(19) United States
(12) Patent Application Publication
(10) Pub. No.: US 2011/0295634 A1
(43) Pub. Date: Dec. 1, 2011

(54) System and Method for Dynamic Optimal Resource Constraint Mapping in Business Process Models

(75) Inventors: Anuradha Bhamidipaty, Bangalore (IN); Seema Prasanth Kumar, Bangalore (IN)

(73) Assignee: INTERNATIONAL BUSINESS MACHINES CORPORATION, Armonk, NY (US)

(21) Appl. No.: 12/789,509

(22) Filed: May 28, 2010

(51) Int. Cl. G06Q 10/00

(52) U.S. Cl. 705/7.12

(57) ABSTRACT

Electronic communication has made it increasingly easier for large companies, such as those with thousands, even tens of thousands, of workers and/or consultants, to maintain steady streams of workflow across scattered offices and locations. In such a context, there is broadly contemplated herein business process modelling comprising the receipt of multiple business process models and resource constraints for each of the models. The models and constraints are then consolidated to more fully optimize business process modelling. Additional resource constraints governing goals of the business unit or organization are also received in embodiments of the invention, as well as resource registry information, (e.g., LDAP information) in addition to resource information such as resource availability and cost, etc. In embodiments of the invention, historical resource-to-task mapping is also assimilated as well as performance characteristics of resources. In other embodiments, dynamic changes to resource information are also considered for resource assignment.

### BACKGROUND

Electronic communication has made it increasingly easier for large companies, such as those with thousands (often, tens of thousands) of workers and/or consultants (who, for the purposes of simplicity, may be referred to as “resources”), to maintain steady streams of workflow across scattered offices and locations. In other words, the increasing irrelevance of geographical constraints has permitted large businesses to assign work tasks to resources in diverse locations on the basis of different practical factors (to be further understood and appreciated herein), as if the workers/consultants were all housed under one roof or along the same hallway.

Typically, in such a context, business process modelling provides a visual platform via which the structure and behavior of business processes can be communicated to stakeholders. Apart from the basic process structure that includes a set of activities and flow constructs, a complete business process model also normally captures information such as resource requirements, task duration, cost information, resource availability schedules and process constraints.

Typical resource-to-task modelling (that is, the general modelling of the assignment of available resources to tasks requiring resources) involves repeatable activities and determinations such that similar or analogous resource-to-task mappings can easily be repeated across processes within a given enterprise. Normally, a business analyst spends considerable time in business process discovery and data collection related to resource-to-task assignments. However, while simulation results in conventional modelling can highlight resource shortages, they have deprived users of an additional degree of utility since they neglect to suggest alternative assignments for resources.

### BRIEF SUMMARY

In summary, one aspect of the invention provides a method comprising: assimilating tasks from a plurality of business processes for resource assignment; assimilating information on available resources for assignment to the tasks; assimilating historical information on resource assignment to tasks; dynamically acquiring new resource information; assigning resources to tasks based on the assimilated historical information and the dynamically acquired new information; outputting a plan of resource assignment to tasks, the plan of resource assignment comprising a first plan and a second plan, the first plan being unrelated to the dynamically acquired new information and the second plan being related to the dynamically acquired new information.

Another aspect of the invention provides an apparatus comprising: one or more processors; and a computer readable storage medium having computer readable program code embodied therewith and executable by the one or more processors, the computer readable program code comprising: computer readable program code configured to assimilate tasks from a plurality of business processes for resource assignment; computer readable program code configured to assimilate information on available resources for assignment to the tasks; computer readable program code configured to assimilate historical information on resource assignment to tasks; computer readable program code configured to dynamically acquire new resource information; computer readable program code configured to assigning resources to tasks based on the assimilated historical information and the dynamically acquired new information; computer readable program code configured to output a plan of resource assignment to tasks, the plan of resource assignment comprising a first plan and a second plan, the first plan being unrelated to the dynamically acquired new information and the second plan being related to the dynamically acquired new information.

An additional aspect of the invention provides a computer program product comprising: a computer readable storage medium having computer readable program code embodied therewith, the computer readable program code comprising: computer readable program code configured to assimilate tasks from a plurality of business processes for resource assignment; computer readable program code configured to assimilate information on available resources for assignment to the tasks; computer readable program code configured to assimilate historical information on resource assignment to tasks; computer readable program code configured to dynamically acquire new resource information; computer readable program code configured to assigning resources to tasks based on the assimilated historical information and the dynamically acquired new information; computer readable program code configured to output a plan of resource assignment to tasks, the plan of resource assignment comprising a first plan and a second plan, the first plan being unrelated to the dynamically acquired new information and the second plan being related to the dynamically acquired new information.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates a process and arrangement of business process modelling in accordance with an example embodiment of the present invention.

FIG. 3 schematically illustrates static resource allocation based on historical data, in accordance with conventional arrangements.

FIG. 4. schematically illustrates dynamic resource allocation based on real time data.

FIG. 5 schematically illustrates dynamic resource allocation based on real time data, while additionally showing effects of new skill acquisition for a resource.

FIG. 6 schematically illustrates dynamic resource allocation based on real time data, while additionally showing effects of a role change within an organization.

FIG. 7 sets forth a process more generally for business process modelling.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

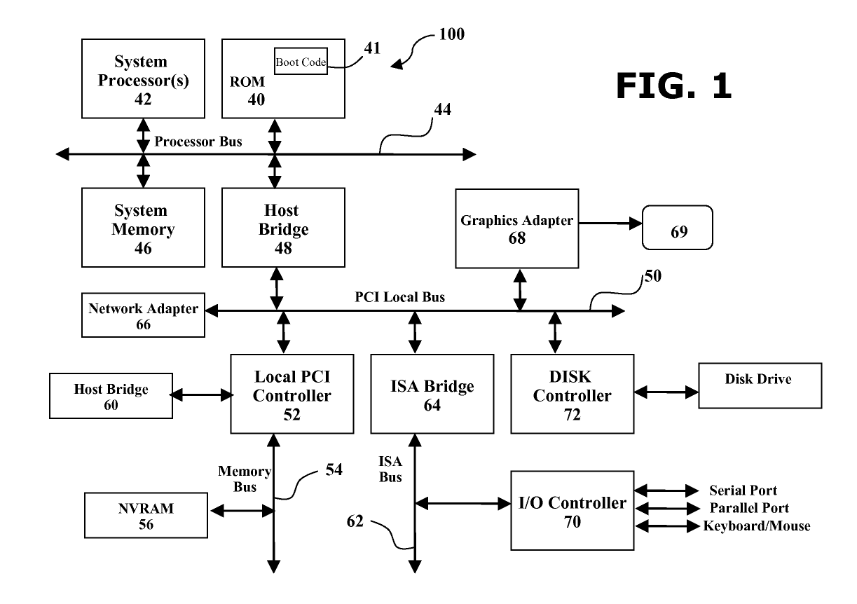

Referring now to FIG. 1, there is depicted a block diagram of an illustrative embodiment of a computer system 100. The illustrative embodiment depicted in FIG. 1 may be an electronic device such as a laptop or desktop personal computer, a mobile/smart phone or the like. As is apparent from the description, however, the embodiments of the invention may be implemented in any appropriately configured device, as described herein.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, et cetera. A disk controller 72 connects a disk drive with PCI local bus 50. The USB Bus and USB Controller (not shown) are part of the Local PCI controller (52).

As will be appreciated herein, in accordance with embodiments of the invention, intelligent resource assignments are made based on similarity of activities across processes. Resource constraints such as availability and cost are incorporated into the model, and can be populated from existing repositories Information present in a user registry is then leveraged, in accordance with embodiments, to complete the resource view of the process model. Further, in embodiments, real time resource details are used to run realistic simulations of human workflow based on current organizational structure, while simulation results provide suggestions for alternative resource assignments in order to maximize throughput.

Reviewing some general background, conventional business process modelling has involved the allocation of work items to resources on the basis of previous execution history. Accordingly, for example, a process model assigns a task to a resource who previously successfully completed the same or similar tasks most often. As historical data are involved, this type of resource allocation is static as it does not rely on changing parameters in the present.

Another type of conventional resource allocation, where no access to historical data is involved, is based on the position of resources within an organization, and their relationship with other users. For instance, allocation rules can be defined here in the manner of “task is performed by superior of X”. This also has resulted in static information in conventional models, in that any updates to such information rarely if ever reach the models in sufficient time to be of optimal assistance.

Conventional business process modelling also involves the application of constraints to models, but these are applied only on a per-process basis. Conflicting resource constraints thus are difficult to resolve, especially in the absence of support for resolving such conflicts at design time.

By way of stark contrast, there is broadly contemplated herein, in accordance with embodiments of the invention, the receipt of multiple business process models and resource constraints for each of the models, wherein these are then consolidated to more fully optimized business process modelling. Additional resource constraints governing goals of the business unit or organization are also received in embodiments of the invention, as well as resource registry information, (e.g., LDAP [lightweight directory access protocol] information) in addition to resource information such as resource availability and cost, etc. In embodiments of the invention, historical resource-to-task mapping is also assimilated as well as performance characteristics of resources.

In accordance with embodiments of the invention, an optimal allocation of resources is determined along with alternatives of resource assignments. A user is then permitted to validate the assignment via simulating human workflow steps, and the user registry is monitored changes, whereby resource-to-task mapping is dynamically re-determined as appropriate. (For the purposes of discussion, “user” may be considered to be an individual or individuals who actually run a process modelling tool to conduct business process modelling, as opposed to resources considered for tasks in the modelling.)

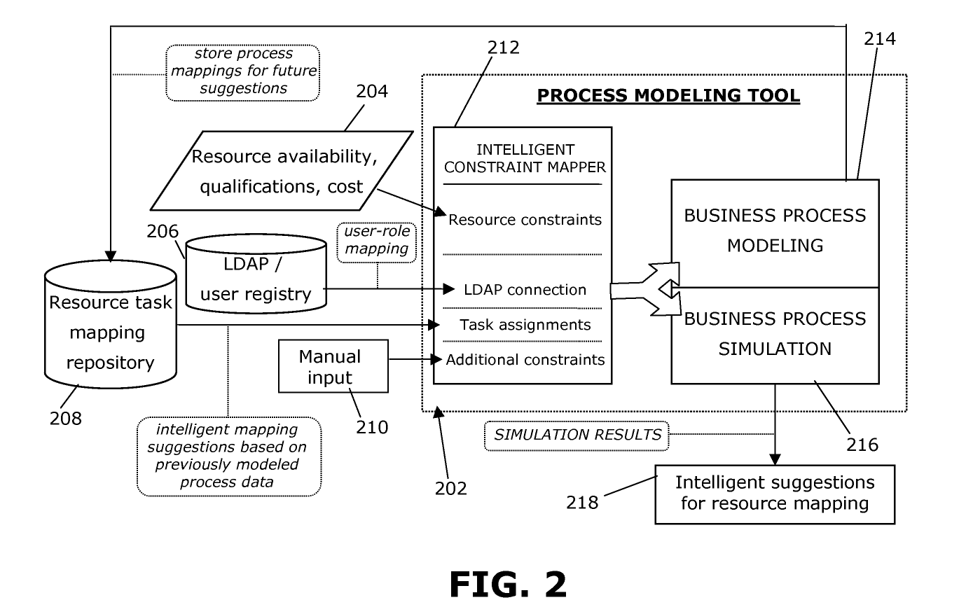

FIG. 2 schematically illustrates a process and arrangement of business process modelling in accordance with an example embodiment of the present invention. It should be appreciated that a process such as that broadly illustrated in FIG. 2 can be carried out on essentially any suitable computer system or set of computer systems, which may, by way of an illustrative and non-restrictive example, include a system such as that indicated at 100 in FIG. 1. In accordance with an example embodiment, most if not all of the process steps discussed with respect to FIG. 2 can be performed by way of system processors and system memory such as those indicated, respectively, at 42 and 46 in FIG. 1, while the designated “process modeling tool” 202 can be embodied by computer readable program code in the form of computer software that is run via system processor 42. Data repositories or databases such as those associated with components 204/206/208 as discussed here below resides in system memory 46 in accordance with example embodiments of the invention. Manual input (210) may be provided via keyboard or other user-accessible input or interface media.

As shown, process modelling tool 202 in an example embodiment receives input from several sources, including (but not necessarily limited to): a database or other data source 204 containing information about resource availability, qualifications, cost and/or other resource attributes; a LDAP/user registry 206; a resource task mapping repository 208; and manual input 210 as may be provided by a user.

Process modeling tool 202 includes, in an example embodiment, an intelligent constraint mapper 212 that serves to collect and consolidate information from the aforementioned sources 204/206/208/210. As such, database 204 provides resource constraints to mapper 212, that is, information governing the extent to which a resource may be employed in a process and their qualifications therefor. LDAP/user registry 206, on the other hand, is different from the other sources in that, in accordance with at least one embodiment of the invention, it contains information on organizational hierarchy. For instance, resource properties such as job role, department, manager, etc., are stored in this input source (206) in accordance with at least one embodiment.

Resource task mapping repository 208, on the other hand, inputs task assignments that previously had been applied and thus impart intelligent mapping suggestions based on previously modeled process data.

Finally, any additional constraints, as deemed appropriate, are entered in an example embodiment via manual input (210). Examples of such additional constraints could include, but by no means are limited to, skill levels, qualification, special needs, etc., which may not be part of a standard set of properties stored in the LDAP/user registry 206.

In at least one embodiment of the invention, process modelling tool 202 then undertakes two actions based on information consolidated via intelligent constraint mapper 212, namely, business process modeling (214) and business process simulation (216). In at least one embodiment of the invention, for effective business process modeling, the process modeling provides suggestions for role assignment computed based on the data available in the various input sources. On the other hand, business process simulation 216 serves to to suggest alternative best choices for resource assignment based on the resource availability at a given point of time.

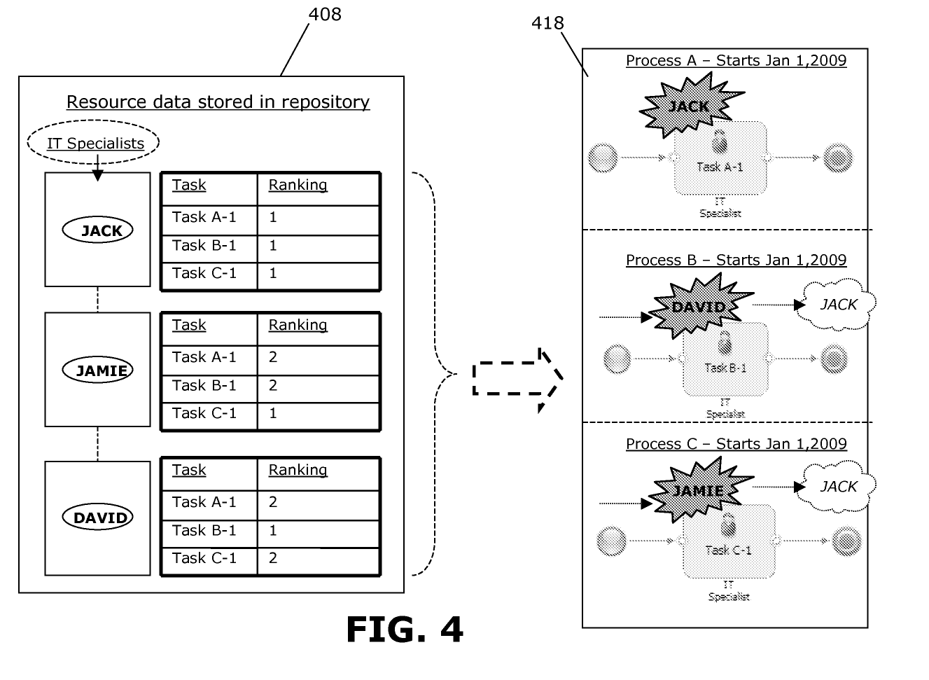

Process mappings (as will be understood more fully herebelow with reference to FIGS. 4-6), in at least one embodiment, are fed back to the resource task mapping repository 208 for use in future modelling or simulation. In other words, information about which resources are assigned to which tasks, in accordance with a business process model that has been undertaken, as well as information on the parameters that fed into such assignments, are stored in repository 208 to be available again to the intelligent constraint mapper 212.

In accordance with an embodiment of the invention, the business process simulation 216 results in intelligent alternative suggestions (218) for resource mapping, as will be more fully appreciated herebelow.

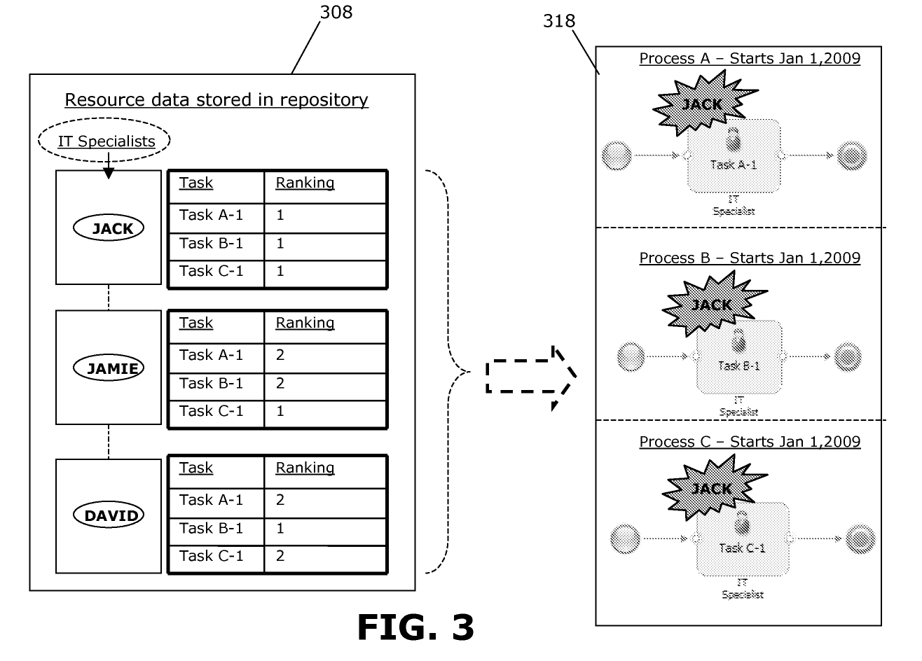

FIG. 3 schematically illustrates static resource allocation based on historical data, in accordance with conventional arrangements. As shown in the present example, repository data 308 can include a list of IT specialists (here labeled Jack, Jamie and David) and, for each of them, a ranking of their readiness to perform, or abilities related to, each of several tasks. Here, Jack, Jamie and David variously have ranks of “1” or “2” for each of the tasks A-1, B-1 and C-1, and are understood to be relative in nature such that a rank of 1 is better than a rank of 2, which is better than a rank of 3, etc. The rankings may be determined by any of a very wide variety of possible criteria and could incorporate, for instance, cost of each resource, an efficiency score, skills/qualifications relative to each task, etc. Generally, the ranking can be computed in essentially any suitable manner, based on, e.g., relative weights assigned to the various resource properties such as skills, qualification, cost, etc.

As shown, in accordance with conventional arrangements, typical simulation results 318 will yield Jack's assignment to each of the tasks A-1, B-1 and C-1. (By way of brief clarification, a task is a single unit of work within a process, whereas a process can be composed of one or more such tasks. In the context of embodiments of the invention, a task does not exist by itself so much as is a part of a business process.)

It should also be clarified and appreciated that in each of the examples of FIGS. 3-6, the order of listing of resources has an influence on assignments to tasks Particularly, the fact that, e.g., Jack is listed above Jamie, who is listed above David indeed represents an additional determining factor in accordance with embodiments of the invention. In other words, when assignments are made, Jack (in the examples of FIGS. 3-6) is normally considered first in the event that other criteria (such as ranks) are “tied”.

Thus, the conventional example of FIG. 3 illustrates a common conventional problem in that Jack is assigned to all of A, B and C. In other words, Jack has a “1” rank for all three categories and, even though, Jamie and David have “1” ranks for C and B, respectively, Jack conventionally is assigned “first” because of the order of the list of resources. [Indeed, embodiments of the invention permit choosing the best resource for a task taking into consideration all available information/data on resource constraints as well as availability factors, and for multiple business processes. As has been a major problem encountered conventionally, evaluating each business process in isolation can lead to conflicting assignments.

The disclosure now turns to processes, in accordance with embodiments of the invention, as shown in FIGS. 4-6. It should be appreciated that processes such as those broadly illustrated in FIGS. 4-6 can be carried out on essentially any suitable computer system or set of computer systems, which may, by way of an illustrative and non-restrictive example, include a system such as that indicated at 100 in FIG. 1. In accordance with example embodiments, most if not all of the process steps discussed and illustrated with respect to FIG. 3 can be performed by way of system processors and system memory such as those indicated, respectively, at 42 and 46 in FIG. 1.

FIG. 4. schematically illustrates dynamic resource allocation based on real time data, in accordance with embodiments of the present invention. As shown, resource data 408 is the same as in the conventional arrangement of FIG. 3. However, here the process executes an additional step of considering more than just rankings and the order of the IT specialists in the list in 408. Particularly, inasmuch as on the basis of rankings and list order alone Jack is assigned to Tasks B-1 and C-1 as in FIG. 3, the additional step recognizes this imbalance in assignments and, instead, reverts to the next specialist further down the list with a ranking of 1. Accordingly, in the example embodiment of FIG. 4, David is assigned to Task B-1 instead of Jack because David is the next specialist (resource) down the list in 408 with a ranking of 1. A similar consideration applies to Jamie and his assignment to Task C-1. Thus, in accordance with embodiments of the invention, a provision is made to resolve an assignment conflict or imbalance as expeditiously as possible.

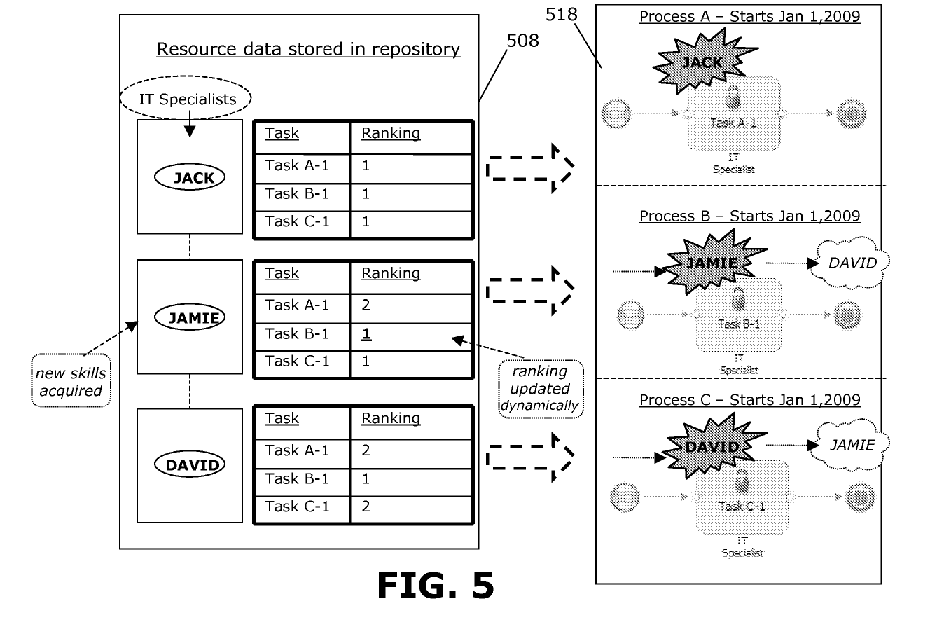

FIG. 5 schematically illustrates dynamic resource allocation based on real time data, while additionally showing effects of new skill acquisition for a resource. Particularly, FIG. 5 shows resource data 508 being updated in accordance with Jamie acquiring new skills which changes his ranking value from 2 to 1 for Task B-1 (e.g., his new skills are particularly relevant to Task B-1, and his ranking for B-1 gets updated). In at least one embodiment of the invention, the updated resource data is pulled from a repository/database such as that indicated at 204 in FIG. 2.

This updating can take place at any time so that by the time a process simulation is run, the results 518 newly take into consideration the change in Jamie's ranking for Task B-1. Accordingly, a new simulation will remove David from Task B-1 as shown and replace him with Jamie, as—after Jack is assigned to Task A-1—Jamie would be the next specialist down the list in 508 with a ranking of 1. Accordingly, David then replaces Jamie for task C-1 as he now is the “best available” (or in this case, only) candidate to take over the task, despite having a ranking of 2. It should thus be appreciated, in accordance with at least one embodiment of the invention, that the algorithm indeed aim to maximize and diversify the distribution of resources across tasks, such that as many different resources are assigned to tasks as possible, even if a resource with a ranking of 1 is not always available for a task. In other words, if resources of ranking 1 are currently assigned to other tasks, the algorithm will choose the next best option, which would be a ranking 2 resource that is currently available (that is, not currently assigned to any task).

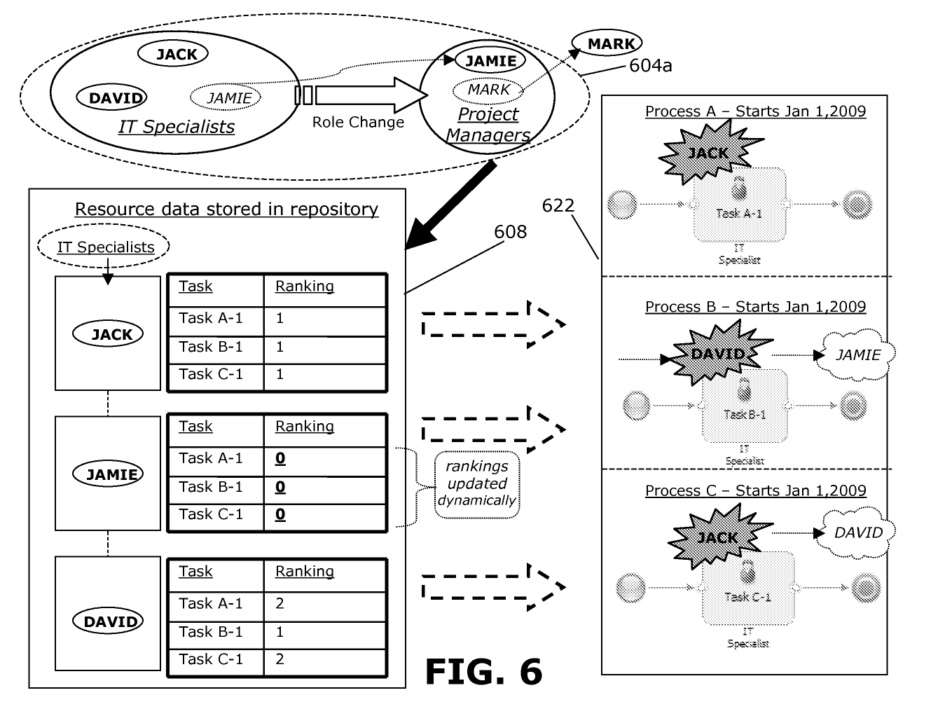

FIG. 6 schematically illustrates dynamic resource allocation based on real time data, while additionally showing effects of a role change within an organization. Thus, organizational information 604a is updated to reflect that as Mark departs as project manager while Jamie gets promoted from IT Specialist to project manager to take Mark's place. As such, resource data 608 is then automatically and dynamically (at any time, regardless of whether a modeling or simulation process is running) updated to accord Jamie a “null” or “dummy” ranking of zero. (Thus, the “zero” rank does not follow the same logic as above, where a rank is of 1 is better than a rank of 2, etc.; instead, in embodiments of the invention, the “zero” rank is taken to mean “not in consideration” for assignment to tasks.) This effectively removes Jamie from consideration in task assignments in modeling, such that new results of a process model (or simulation) run will show Jamie leaving Task B-1 to be replaced by David (since David is the next down the list in 608 with a ranking of 1, or in this case is the only remaining candidate on the list). A conflict then needs to be resolved for Task C-1, which in this case is resolved in favor of Jack. Particularly, as Jack has a ranking of 1 for Task C-1, he gets assigned the task; the standing rule of according as much diversity in assignments as possible is overridden or at least modified here in that there are no longer three candidates for three tasks, so one candidate will need to take on two tasks. (The same results 622 would hold here, in embodiments of the invention, if David had a ranking of 1 for Task C-1; the “tiebreaker” would then be Jack's higher position on the list in data 608.)

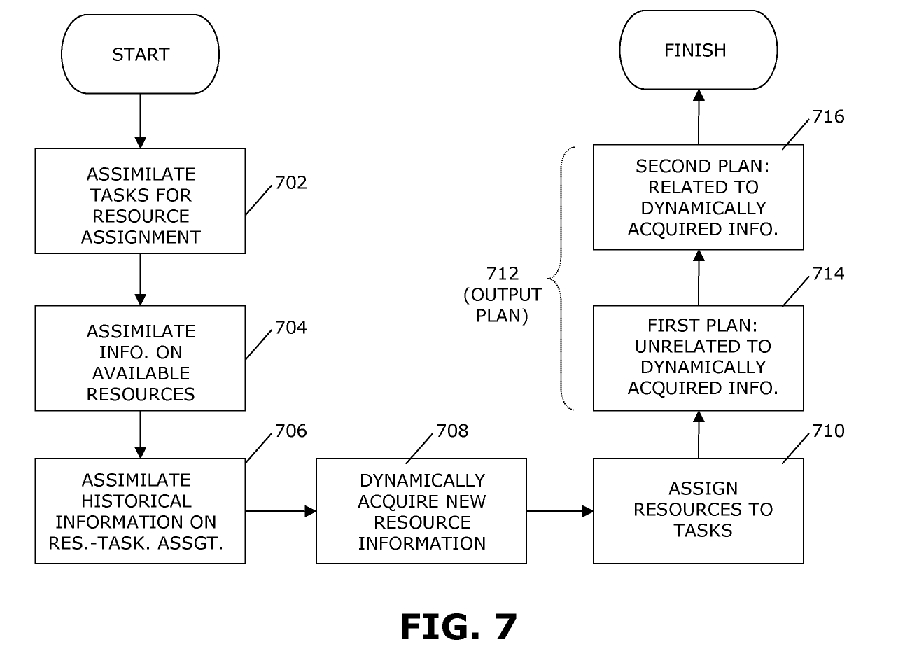

FIG. 7 sets forth a process more generally for a business modeling process, in accordance with at least one embodiment of the present invention. It should be appreciated that a process such as that broadly illustrated in FIG. 7 can be carried out on essentially any suitable computer system or set of computer systems, which may, by way of an illustrative and on-restrictive example, include a system such as that indicated at 100 in FIG. 1. In accordance with an example embodiment, most if not all of the process steps discussed with respect to FIG. 7 can be performed by way of system processors and system memory such as those indicated, respectively, at 42 and 46 in FIG. 1.

As shown in FIG. 7, tasks are assimilated for resource assignment (702) along with information on available resources for assignment to the tasks (704). Historical information on resource assignment to tasks is assimilated (706). Thereafter, new resource information is dynamically acquired (708), and resources are assigned to tasks based on the assimilated historical information and the dynamically acquired new information (710). Then, in outputting a plan of resource assignment to tasks (712), a first plan is developed (714) that is unrelated to the dynamically acquired new information while a second plan is developed (716) that is related to the dynamically acquired new information.

In brief recapitulation, it will be appreciated that embodiments of the invention permit, advantageously, the pooling of unused capacities of multiple resources to create flexible execution plans with adjustable effort boundaries for atomic tasks. While nominally atomic tasks are associated with employing a single resource, embodiments of the invention permit multiple individuals to collaborate on a task at execution time, while making adjustments to estimated effort to account for collaboration/transaction costs. As a result of employing a planning engine in accordance with embodiments of the invention, it is possible to complete more tasks on time and avoid penalties, which can lead to being able to accept more tasks and increase revenue, reduce the idle time of resources and promote more collaboration across team members to thereby improve future organizational performance.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
assimilating tasks from a plurality of business processes for resource assignment;
assimilating information on available resources for assignment to the tasks;
assimilating historical information on resource assignment to tasks;
dynamically acquiring new resource information;
assigning resources to tasks based on the assimilated historical information and the dynamically acquired new information;
outputting a plan of resource assignment to tasks, the plan of resource assignment comprising a first plan and a second plan, the first plan being unrelated to the dynamically acquired new information and the second plan being related to the dynamically acquired new information.

2. The method according to claim 1, further comprising assimilating rank values for resources relative to available tasks.

3. The method according to claim 2, wherein the rank values relate to historical information on resource assignment to tasks.

4. The method according to claim 2, wherein said dynamic acquiring of new resource information comprises updating a resource rank value responsive to new resource information.

5. The method according to claim 4, wherein said dynamic acquiring of new resource information comprises acquiring information on revised resource skills and updating a resource rank value.

6. The method according to claim 4, wherein said dynamic acquiring of new resource information comprises acquiring information on a revised resource position within an organization and updating a resource rank value.

7. The method according to claim 1, wherein said assimilating information comprises assimilating lightweight directory access protocol information.

8. The method according to claim 1, wherein said dynamic acquiring of new resource information comprises acquiring manually input information.

9. The method according to claim 1, wherein said outputting of a second plan comprises minimizing the number of tasks assigned to each resource.

10. An apparatus comprising:
one or more processors; and
a computer readable storage medium having computer readable program code embodied therewith and executable by the one or more processors, the computer readable program code comprising:
computer readable program code configured to assimilate tasks from a plurality of business processes for resource assignment;
computer readable program code configured to assimilate information on available resources for assignment to the tasks;
computer readable program code configured to assimilate historical information on resource assignment to tasks;
computer readable program code configured to dynamically acquire new resource information;
computer readable program code configured to assigning resources to tasks based on the assimilated historical information and the dynamically acquired new information;
computer readable program code configured to output a plan of resource assignment to tasks, the plan of resource assignment comprising a first plan and a second plan, the first plan being unrelated to the dynamically acquired new information and the second plan being related to the dynamically acquired new information.

11. The apparatus according to claim 10, wherein said computer readable program code is configured to assimilate rank values for resources relative to available tasks.

12. A computer program product comprising:
a computer readable storage medium having computer readable program code embodied therewith, the computer readable program code comprising:
computer readable program code configured to assimilate tasks from a plurality of business processes for resource assignment;
computer readable program code configured to assimilate information on available resources for assignment to the tasks;
computer readable program code configured to assimilate historical information on resource assignment to tasks;
computer readable program code configured to dynamically acquire new resource information;
computer readable program code configured to assigning resources to tasks based on the assimilated historical information and the dynamically acquired new information;
computer readable program code configured to output a plan of resource assignment to tasks, the plan of resource assignment comprising a first plan and a second plan, the first plan being unrelated to the dynamically acquired new information and the second plan being related to the dynamically acquired new information.

13. The computer program product according to claim 12, wherein said computer readable program code is configured to assimilate rank values for resources relative to available tasks.

14. The computer program product according to claim 13, wherein the rank values relate to historical information on resource assignment to tasks.

15. The computer program product according to claim 13, wherein said computer readable program code is configured to update a resource rank value responsive to new resource information.

16. The computer program product according to claim 15, wherein said computer readable program code is configured to dynamically acquire information on revised resource skills.

17. The computer program product according to claim 15, wherein said computer readable program code is configured to dynamically acquire information on a revised resource position within an organization.

18. The computer program product according to claim 12, wherein said computer readable program code is configured to output a second plan via minimizing the number of tasks assigned to each resource.

19. The computer program product according to claim 12, wherein said assimilating information comprises assimilating lightweight directory access protocol information.

20. The computer program product according to claim 12, wherein said dynamic acquiring of new resource information comprises acquiring manually input information.
